(19) United States
(12) Patent Application Publication
(10) Pub. No.: US 2025/0200215 A1
(43) Pub. Date: Jun. 19, 2025

(54) SYSTEMS AND METHODS FOR DEVICE CONTENT PRIVACY

(71) Applicant: MOUNT ENTERPRISES PTY LTD, Geelong, Victoria (AU)

(72) Inventor: CHRISTOPHER CHARLES FRESLE, Geelong, Victoria (AU)

(73) Assignee: MOUNT ENTERPRISES PTY LTD, Geelong, Victoria (AU)

(21) Appl. No.: 18/849,821

(22) PCT Filed: Mar. 22, 2023
(86) PCT No.: PCT/AU2023/050207

§ 371 Date: Sep. 23, 2024

(30) Foreign Application Priority Data
Mar. 23, 2022 (AU) 2022900733

(51) Int. Cl. G06F 21/62; G06F 21/32; G06F 21/84; G06V 40/16

(52) U.S. Cl. CPC G06F 21/6245; G06F 21/32; G06F 21/84; G06V 40/162; G06V 40/172

(57) ABSTRACT

A system for providing privacy measures for a computing device comprising: a memory a display configured to display images and/or data which may be subject to privacy concerns; at least one image sensor configured to provide image data of a user operating the computing device and image data of the environment surrounding the user within an image sensor field of view; at least one processor configured to: receive the image data to segment the image data to isolate the facial features of a person comprising a user and generate a user facial vector representative of characteristics of the segmented facial image data; and compare the user facial vector with facial vector data associated with one or more authorised device users stored in the memory; and a privacy controller module configured to determine a privacy threat alert based on the facial vector comparison; wherein, on receipt of a privacy threat alert from the privacy controller, the processor is configured to modify the display of the electronic device to preserve the privacy of the displayed image and/or data.

### FIELD OF THE INVENTION

The present invention relates to privacy applications for electronic devices and in particular to software applications for preserving content privacy of electronic devices.

The systems and methods disclosed herein relate to computer hardware and computer software executed on computer hardware, computer-based systems, and computer-based methods for maintaining computer user privacy while using computer-based data processing and communications equipment. The technology herein has applications in the areas of data processing, portable computing, computer-based communications, computer security, and data privacy maintenance.

The invention has been developed primarily for use in methods and systems for the protection of private electronic content displayed on a user's electronic device, including mobile phones, tables, or computer systems, and will be described hereinafter with reference to this application. However, it will be appreciated that the invention is not limited to this particular field of use.

### BACKGROUND

Any discussion of the background art throughout the specification should in no way be considered as an admission that such background art is prior art, nor that such background art is widely known or forms part of the common general knowledge in the field in Australia or worldwide as at the priority date of the present application.

All references, including any patents or patent applications, cited in this specification are hereby incorporated by reference, which means that it should be read and considered by the reader as part of this text. That the document, reference, patent application or patent cited in this text is not repeated in this text is merely for reasons of conciseness.

No admission is made that any reference or documentation cited in the present specification constitutes prior art. The discussion of the references states what their authors assert, and the applicants reserve the right to challenge the accuracy and pertinence of the cited documents. It will be clearly understood that, although a number of prior art publications may be referred to herein, such reference does not constitute an admission that any of these documents forms part of the common general knowledge in the art, in Australia or in any other country, at the priority date of the application.

Off-the-shelf desktop and portable computers and computer-controlled devices, such as laptop computers, netbooks, tablet computers, personal digital assistants (“PDAs”), and smartphones (referred to generally herein as a “device” or “devices”), cannot adequately maintain privacy for information displayed to the user while the device is in use. It is possible for unauthorized persons to see, or even record, such information from nearby locations, such as over the shoulder of the device user, while the authorized user is viewing it, a practice commonly referred to as “shoulder surfing”. With the increasing use of portable computing devices in public locations, display of information in a manner that permits unauthorized viewing, whether in public, semi-public, and even restricted locations, is becoming increasingly problematic. For instance, a patient's medical records brought up on a screen in a doctor's office might be viewable by those sitting in a nearby waiting room, or by maintenance personnel working in the office. An e-mail announcing the award of a major contract to a publicly held company might be composed in an airport lobby, and viewed by another passenger waiting nearby who spreads this sensitive information before it was intended to be publicly known. There are many ways that unauthorized viewing of displayed data can result in harm or loss. Restricting display of sensitive data to times or locations where privacy can be ensured is not a practical solution to this problem given the pace of modern business and life in general combined with the ever-increasing capabilities of portable computing equipment. Some means of permitting the display of information to authorized users, while detecting, limiting or preventing disclosure to others, is needed.

Prior art technology for the protection of displayed data includes software commonly referred to as screen savers. Originally created to prevent damage to Cathode Ray Tube (“CRT”) monitors, which could “burn-in” a persistently displayed image and leave it permanently displayed on the CRT's phosphor, these programs also have some utility for preventing unauthorized viewing of on-screen data or even use of the computer. When there has been no user input to the computer (e.g., keyboard input or pointing device movement) for a set period of time, generally anything from one minute to 15 minutes, the screen saver activates and replaces the displayed information with some non-static display, such as a slide show of images, output of a graphic generating program, scrolling message, etc. When input resumes, such as by typing a key or moving a mouse, the screen saver deactivates and the prior information display is restored. Some screen savers support a requirement that re-authentication be performed, such as by entering a password, before the screen saver will deactivate and return to the prior display. However, while screen savers can offer some limit to the access of displayed data when the user is not using the computer, they have several serious limitations when it comes to preserving privacy of on-screen data: First, screen savers do not protect data privacy while the user is actively working; second, there is a delay between the user ceasing work, and perhaps moving away from the computer, and the screen saver activating; and third, anyone can prevent activation of the screen saver after the authorized user leaves the area by providing input to the computer, such as by moving the mouse or pressing a key on the keyboard, and thus gain extra time to read the display.

Another prior art technology for privacy protection is the “privacy filter”, a physical device that can be added to the front of a display to reduce the angle of visibility of the display and limit or completely block viewing at predetermined angles. Such privacy filters also have significant limitations, since they can do nothing to prevent unauthorized viewing from a position directly behind the user and are sometimes less effective at reducing visibility angles from above or below than they are at reducing visibility angles from the sides. Their limited effectiveness is especially pronounced with monitors that can be rotated between “portrait” and “landscape” orientations. Privacy filters also can sometimes reduce the available display brightness by 40% or more and may also change display contrast or distort the display image, so some users, especially those with some degree of sight impairment, do not like using them. Privacy filters are also typically removable, which permits users to disable their protection and so to violate security policies, without such violations being detectable.

Both of the above-described prior art techniques for protecting the display of information on a computer from authorized viewing also suffer from their inherent “all-or-nothing” scope, i.e., either must be applied to the entire screen.

Moreover, the above-described methods and systems are usually applied in a static or modal format. In other words, the user must implement some command or other deliberate action to change the degree of security to the extent any such change in degree is possible. For example, users often want to view data displays and sensitive information not only in relatively secure locations, such as their offices, but also in homes, coffee shops, airports and other unsecured environments where unauthorized individuals or devices can also view their displays, possibly without their knowledge. But users often forget to make adjustments to their security settings to account for the loss of privacy when moving from office to public spaces, thus risking both deliberate arid inadvertent security compromise. Thus, some way to automatically adjust the level of security in accordance with the computer's and user's environment would be helpful.

The needs described above are addressed by the present invention, as described using the exemplary embodiments disclosed herein as understood by those with ordinary skill in the art.

### SUMMARY

It is an object of the present invention to overcome or ameliorate at least one or more of the disadvantages of the prior art, or to provide a useful alternative.

According to a first aspect of the invention, there is provided a system for providing privacy measures for a computing device. The system may comprise a memory. The system may further comprise a display configured to display images and/or data which may be subject to privacy concerns. The system may further comprise at least one image sensor configured to provide image data of a person comprising a user operating the computing device and image data of the environment surrounding the user within an image sensor field of view. The system may further comprise at least one processor. The processor may be configured to receive the image data to segment the image data to isolate the facial features of the user and generate a user facial vector representative of characteristics of the segmented facial image data. The processor may be further configured to compare the user facial vector with facial vector data associated with one or more authorised device users stored in the memory. The system may further comprise a privacy controller module configured to determine a privacy threat alert based on the facial vector comparison. On receipt of a privacy threat alert from the privacy controller, the processor may be configured to modify the display of the electronic device to preserve the privacy of the displayed image and/or data.

According to a particular arrangement of the first aspect, there is provided a system for providing privacy measures for a computing device comprising:
a memory;
a display configured to display images and/or data which may be subject to privacy concerns;
at least one image sensor configured to provide image data of a person comprising a user operating the computing device and image data of the environment surrounding the user within an image sensor field of view;
at least one processor configured to:
   receive the image data to segment the image data to isolate the facial features of the user and generate a user facial vector representative of characteristics of the segmented facial image data; and
   compare the user facial vector with facial vector data associated with one or more authorised device users stored in the memory; and
a privacy controller module configured to determine a privacy threat alert based on the facial vector comparison;
wherein, on receipt of a privacy threat alert from the privacy controller, the processor is configured to modify the display of the electronic device to preserve the privacy of the displayed image and/or data.

The memory may be configured for storing facial vector with facial recognition data. The facial recognition data may comprise facial vector with facial vector data.

The processor may be configured to further segment the image data to identify a person or object within the field of view of the image sensor. The processor may be configured to further segment the image data forming further segmented image data, to identify either, a further person, or an object within the field of view of the image sensor from the further segmented image data. The object may be an image and/or video recording device.

The privacy controller may be configured to determine a privacy threat on the basis of the further segmented image data, such that, in use, on identification of a privacy threat, the privacy controller causes the processor to modify the display of the electronic device to preserve the privacy of the data previously being shown on the display

Modification of the display may comprise displaying an image or message at least partially obscuring the displays image or data. Modification of the display may comprise either blacking out the display or turning the display to an ‘off’ state.

According to a second aspect of the invention, there is provided a computer program product for electronic device privacy. The computer program product may comprise a non-transitory computer readable storage medium having computer readable program code portions stored therein. The computer readable program code portions may comprise a first portion configured to receive image data from an image sensor. The computer readable program code portions may further comprise a second portion configured to segment the image data to isolate the facial features of a person comprising a user and generate a user facial vector representative of characteristics of the segmented facial image data. The computer readable program code portions may further comprise a third portion configured to compare the user facial vector with facial vector data of known users authorised to access the electronic device, wherein such facial vector data of known authorised users may be stored in a memory. The computer readable program code portions may further comprise a fourth portion configured to modify a display of the electronic device to obscure or remove image or data from being displayed on the electronic device display.

According to a particular arrangement of the second aspect of the invention, there is provided a computer program product for electronic device privacy, the computer program product comprising a non-transitory computer readable storage medium having computer readable program code portions stored therein, the computer readable program code portions comprising:
a first portion configured to receive image data from an image sensor;
a second portion configured to segment the image data to isolate the facial features of a person comprising a user and generate a user facial vector representative of characteristics of the segmented facial image data;
a third portion configured to compare the user facial vector with facial vector data of known users authorised to access the electronic device; and
a fourth portion configured to modify a display of the electronic device to obscure or remove image or data from being displayed on the electronic device display.

The computer program product may further comprise:
a fifth portion configured to further segment the image data, forming further segmented image data, to identify either, a further person or an object within the field of view of the image sensor; and
a sixth portion configured to determine a privacy threat on the basis of the further segmented image data, such that, in use, on identification of a privacy threat, the sixth portion engages the fourth portion to modify the display of the electronic device to preserve the privacy of the data previously being shown on the display. The object may comprise an image and/or video recording device.

Modification of the display may comprises displaying an image or message at least partially obscuring the displays image or data. Modification of the display may comprise either blacking out the display or turning the display to an ‘off’ state.

According to a third aspect of the invention, there is provided a method of providing privacy measures for a computing device. The method may comprise the step of providing a display configured to display images and/or data which may be subject to privacy concerns. The method may comprise the further step of providing at least one image sensor configured to provide image data of a person comprising a user operating the computing device and image data of the environment surrounding the user within an image sensor field of view. The method may comprise the further step of providing at least one processor configured to receive the image data; segment the image data to isolate the facial features of the user and generate a user facial vector representative of characteristics of the segmented facial image data; compare the user facial vector with facial vector data associated with one or more authorised device users stored in the memory. The method may comprise the further step of providing a privacy controller module configured to determine a privacy threat alert based on the facial vector comparison. On receipt of a privacy threat alert from the privacy controller, the processor may be configured to modify the display of the electronic device to preserve the privacy of the displayed image and/or data.

According to a particular arrangement of the third aspect, there is provided a method of providing privacy measures for a computing device comprising the steps of:
providing a display configured to display images and/or data which may be subject to privacy concerns;
providing at least one image sensor configured to provide image data of a person comprising a user operating the computing device and image data of the environment surrounding the user within an image sensor field of view;
providing at least one processor configured to: receive the image data;
segment the image data to isolate the facial features of the user and generate a facial vector representative of characteristics of the segmented facial image data;
compare the facial vector with facial vector data associated with one or more authorised device users stored in the memory; and
providing a privacy controller module configured to determine a privacy threat alert based on the facial vector comparison;
wherein, on receipt of a privacy threat alert from the privacy controller, the processor is configured to modify the display of the electronic device to preserve the privacy of the displayed image and/or data.

The method may comprise the further step of: further segmenting the image data using the processor forming further segmented image data, to identify either, a further person and/or or an object within the field of view of the image sensor.

The device may be an image and/or video recording device.

The privacy controller may be configured to determine a privacy threat on the basis of the further segmented image data, such that, in use, on identification of a privacy threat, the processor is directed to modify the display of the electronic device to preserve the privacy of the data previously being shown on the display.

Modification of the display may comprise displaying an image or message at least partially obscuring the displays image or data. Modification of the display may comprise either blacking out the display or turning the display to an ‘off’ state.

According to a fourth aspect of the invention, there is provided a computer program product having a computer readable medium having a computer program recorded therein for providing privacy measures for a computing device. The computing device may comprise at least one processor. The computing device may further comprise a memory. The computing device may further comprise at least one image sensor. The computing device may further comprise a display. The computer program product may comprise computer program code means for displaying images and/or data which may be subject to privacy concerns. The computer program product may further comprise computer program code means for receiving image data from the at least one image sensor, the image data comprising image data of a person comprising a user operating the computing device and image data of the environment surrounding the user within an image sensor field of view. The computer program product may further comprise computer program code means for segmenting the image data to isolate the facial features of a user and generate a user facial vector representative of characteristics of the segmented facial image data. The computer program product may further comprise computer program code means for comparing the user facial vector with facial vector data associated with one or more authorised device users stored in the memory. The computer program product may further comprise computer program code means for providing a privacy controller module configured to determine a privacy threat alert based on the facial vector comparison. The computer program product may further comprise computer program code means for, on receipt of a privacy threat alert from the privacy controller, configuring the processor to modify the display of the electronic device to preserve the privacy of the displayed image and/or data.

According to a particular arrangement of the fourth aspect, there is provided a computer program product having a computer readable medium having a computer program recorded therein for providing privacy measures for a computing device, the computing device comprising:
at least one processor;
a memory;
at least one image sensor;
a display;
said computer program product comprising:
   computer program code means for displaying images and/or data which may be subject to privacy concerns;
   computer program code means for receiving image data from the at least one image sensor, the image data comprising image data of a person comprising a user operating the computing device and image data of the environment surrounding the user within an image sensor field of view;
   computer program code means for segmenting the image data to isolate the facial features of a user and generate a user facial vector representative of characteristics of the segmented facial image data;
   computer program code means for comparing the user facial vector with facial vector data associated with one or more authorised device users stored in the memory computer program code means for providing a privacy controller module configured to determine a privacy threat alert based on the facial vector comparison;
   computer program code means for, on receipt of a privacy threat alert from the privacy controller, the processor is configured to modify the display of the electronic device to preserve the privacy of the displayed image and/or data.

The computer program product may further comprise computer program code means for further segmenting the image data using the processor forming further segmented image data to identify either, a further person, or an object within the field of view of the image sensor.

The object may be an image and/or or video recording device.

One embodiment provides a computer program product for performing a method as described herein.

One embodiment provides a non-transitive carrier medium for carrying computer executable code that, when executed on a processor, causes the processor to perform a method as described herein.

One embodiment provides a system configured for performing a method as described herein.

### BRIEF DESCRIPTION OF THE DRAWINGS

Notwithstanding any other forms which may fall within the scope of the present invention, a preferred embodiment/preferred embodiments of the invention will now be described, by way of example only, with reference to the accompanying drawings in which:

FIG. 1 shows a computing device on which the various embodiments described herein may be implemented in accordance with an embodiment of the present invention;

FIG. 2 shows an embodiment of the invention described herein in use;

FIG. 3 shows a schematic depiction of the operation of a privacy controller for a computing device as disclosed herein; and

FIG. 4 shows a block diagram that illustrates an example computer system with which an embodiment may be implemented.

In the drawings, like structures are referred to by like numerals throughout the several views. The drawings shown are not necessarily to scale, with emphasis instead generally being placed upon illustrating the principles of the present invention.

### Definitions

The following definitions are provided as general definitions and should in no way limit the scope of the present invention to those terms alone, but are put forth for a better understanding of the following description.

Unless defined otherwise, all technical and scientific terms used herein have the same meaning as commonly understood by those of ordinary skill in the art to which the invention belongs. It will be further understood that terms used herein should be interpreted as having a meaning that is consistent with their meaning in the context of this specification and the relevant art and will not be interpreted in an idealized or overly formal sense unless expressly so defined herein. For the purposes of the present invention, additional terms are defined below. Furthermore, all definitions, as defined and used herein, should be understood to control over dictionary definitions, definitions in documents incorporated by reference, and/or ordinary meanings of the defined terms unless there is doubt as to the meaning of a particular term, in which case the common dictionary definition and/or common usage of the term will prevail.

For the purposes of the present invention, the following terms are defined below.

The articles “a” and “an” are used herein to refer to one or to more than one (i.e., to at least one) of the grammatical object of the article. By way of example, “an element” refers to one element or more than one element.

The term “about” is used herein to refer to quantities that vary by as much as 30%, preferably by as much as 20%, and more preferably by as much as 10% to a reference quantity. The use of the word ‘about’ to qualify a number is merely an express indication that the number is not to be construed as a precise value.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

Any one of the terms: “including” or “which includes” or “that includes” as used herein is also an open term that also means including at least the elements/features that follow the term, but not excluding others. Thus, “including” is synonymous with and means “comprising”.

In the claims, as well as in the summary above and the description below, all transitional phrases such as “comprising”, “including”, “carrying”, “having”, “containing”, “involving”, “holding”, “composed of”, and the like are to be understood to be open-ended, i.e., to mean “including but not limited to”. Only the transitional phrases “consisting of” and “consisting essentially of” alone shall be closed or semi-closed transitional phrases, respectively.

The term, “real-time”, for example “displaying real-time data”, refers to the display of the data without intentional delay, given the processing limitations of the system and the time required to accurately measure the data. Similarly, a process occurring “in real time” refers to operation of the process without intentional delay or in which some kind of operation occurs simultaneously (or nearly simultaneously) with when it is happening.

The term, “near-real-time”, for example “obtaining real-time or near-real-time data” refers to the obtaining of data either without intentional delay (“real-time”) or as close to real-time as practically possible (i.e., with a small, but minimal, amount of delay whether intentional or not within the constraints and processing limitations of the of the system for obtaining and recording or transmitting the data.

Although any methods and materials similar or equivalent to those described herein can be used in the practice or testing of the present invention, preferred methods and materials are described. It will be appreciated that the methods, apparatus and systems described herein may be implemented in a variety of ways and for a variety of purposes. The description here is by way of example only.

As used herein, the term “exemplary” is used in the sense of providing examples, as opposed to indicating quality. That is, an “exemplary embodiment” is an embodiment provided as an example, as opposed to necessarily being an embodiment of exemplary quality for example serving as a desirable model or representing the best of its kind.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer-readable storage medium (or multiple computer-readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The phrase “and/or”, as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of”, or, when used in the claims, “consisting of” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either”, “one of”, “only one of”, or “exactly one of.” “Consisting essentially of”, when used in the claims, shall have its ordinary meaning as used in the field of patent law.

As used herein in the specification and in the claims, the phrase “at least one”, in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B”, or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

For the purpose of this specification, where method steps are described in sequence, the sequence does not necessarily mean that the steps are to be carried out in chronological order in that sequence, unless there is no other logical manner of interpreting the sequence.

In addition, where features or aspects of the invention are described in terms of Markush groups, those skilled in the art will recognise that the invention is also thereby described in terms of any individual member or subgroup of members of the Markush group.

### DETAILED DESCRIPTION

### Privacy Controller

Disclosed herein are systems and methods for maintaining user privacy while using personal computing devices, in particular mobile computing devices including smartphones, tablets and laptops or portable computing devices.

Portable computing devices ubiquitously provide multiple camera devices including at least one forward-facing camera device such that the user of the device is within the field of view of the forward-facing camera whilst the phone is in use.

A facial recognition system is a technology capable of matching a human face from a digital image or a video frame against a database of faces, typically employed to authenticate users through ID verification services, works by pinpointing and measuring facial features from a given image.

Since their inception, facial recognition systems have seen wider uses in recent times on smartphones and in other forms of technology, such as robotics. Because computerized facial recognition involves the measurement of a human's physiological characteristics, facial recognition systems are categorized as biometrics. Although the accuracy of facial recognition systems as a biometric technology is lower than iris recognition and fingerprint recognition, it is widely adopted due to its contactless process and ease of integration with portable computing devices such as smartphones ant tablets in conjunction with the forward-facing camera included with such devices. Facial recognition systems have been deployed in advanced human-computer interaction, video surveillance and automatic indexing of images.

Facial recognition systems are employed throughout the world today by governments and private companies. Their effectiveness varies, and some systems have previously been scrapped because of their ineffectiveness. The use of facial recognition systems has also raised controversy, with claims that the systems violate citizens' privacy, commonly make incorrect identifications, encourage gender norms and racial profiling, and do not protect important biometric data. However, their accuracy and usefulness is improving and facial recognition is often available as a means for identifying the true user or owner of a portable computing device in which to unlock the device from a locked state for use by the authenticated user.

While humans can recognize faces without much effort, facial recognition is a challenging pattern recognition problem in computing. Facial recognition systems attempt to identify a human face, which is three-dimensional and changes in appearance with lighting and facial expression, based on its two-dimensional image. To accomplish this computational task, facial recognition systems typically perform four steps. First, face detection is used to segment the face from the image background. Secondly, the segmented face image is aligned to account for face pose, image size and photographic properties, such as illumination and grayscale. The purpose of the alignment process is to enable the accurate localization of facial features in the Third step, the facial feature extraction. Features such as eyes, nose and mouth are pinpointed and measured in the image to represent the face and a feature map or vector (a user facial vector) is generated incorporating the measured facial features. The user facial vector is then, in the Fourth step, matched against a database of faces. In the example of user authentication, the user facial vector is matched against a database of authorised users stored in the memory of the computing device. If the measured user facial vector is matched against a stored facial vector, user access is granted to the computing device.

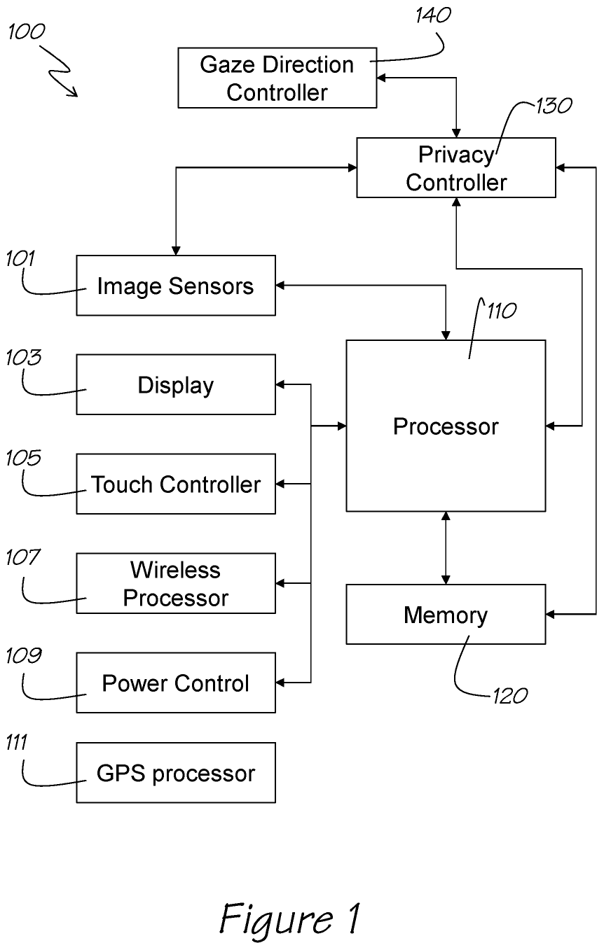

FIG. 1 schematically illustrates an electronic device 100 according to aspects of the invention as described herein. In one embodiment, the electronic device 100 is a mobile computing device such as, for example, a smartphone, tablet or laptop computing device, with a processor 110 in communication with a memory 120. The processor 110 may be a central processing unit and/or a graphics processing unit. The memory 120 is a combination of flash memory and random-access memory. The memory 120 stores a privacy controller 130 to implement operations of the invention. The privacy controller 130 may include executable instructions to access a server (not shown) that coordinates operations disclosed herein. Alternately, the privacy controller 130 may include executable instructions to coordinate some of the operations disclosed herein, while the server implements other operations. Device 100 may further optionally include a gaze direction controller 140.

The processor 110 is also coupled to image sensors 101. The image sensors 101 may be known as digital image sensors, such as charge-coupled devices. The image sensors capture visual media, which is recorded by processor 110 and presented on display 103. Images captured by the digital image sensors 101 may also be stored in memory 120 of device 100.

A touch controller 105 is connected to the display 103 and the processor 110. The touch controller 105 is responsive to haptic signals applied to the display 103.

In one embodiment, the privacy controller 130 monitors signals from the image sensor 101. If suspicious activity is observed by the image sensors 101, then the privacy controller causes the display 103 to be switched off or alternatively to display a message on the screen which obscures the image(s) currently displayed on display 103.

The electronic device 100 may also include other components commonly associated with a smartphone, such as a wireless signal processor 107 to provide connectivity to a wireless network. A power control circuit 109 and a global positioning system processor 111 may also be utilized. While many of the components of FIG. 1 are known in the art, new functionality is achieved through the privacy controller 130, optionally operating in conjunction with a server (not shown) configured to undertake one or more of the functions of privacy controller 130 as discussed herein.

In embodiments of the presently disclosed systems and methods, privacy controller 130 of computing device 100 continuously monitors the user environment in which the portable computing device is in during use by a user. In preferred embodiments of the portable computing device, the privacy controller is executed in a system layer that is not immediately visible to the user of the device, nor to any unauthorised users attempting to access the device without permission.

Privacy module preferably is continually engaged by the device processor 110 as a background service to ensure that only authorised users of the portable computing device 100 are permitted to operate the device or view information displayed on display device 103.

### User Authentication

In a first function of the privacy controller embodied within a software application installed on device 100 described herein, when the device 100 is switched on or woken up from a low power state, when the privacy protection software module is in an active or executing state, for example, as a background process running on device 100, central processor 110 of the device 100 activates a forward-facing camera module 101 of the device and records a two-dimensional image of a user attempting to access the device 100 and generates a user facial vector based upon features of the user's face detected in the recorded image. The user facial vector is passed to privacy controller 130 which authenticates the user facial vector by matching the user facial vector to predefined facial vectors of authorised users of device 10 which are stored in device memory 120. Where the generated user facial vector is authenticated with sufficient confidence to a stored authorised facial vector, the privacy controller passes a flag to processor 110 that the user is permitted to use the device and thus the processor is able to activate the device display 103.

Subsequent to initial user authentication, particular applications of the privacy controller may continue to monitor real-time image data from the forward-facing camera module to continue to track that the face of the authorised user remains within the image data. In particular arrangements, the privacy controller 130 may not regularly repeat the user authentication procedure, but rather, monitor the image data to confirm that, once authenticated, the authenticated face remains in the field of view of the camera module 101. The privacy controller 130 may be configured, after initial authentication, to monitor merely for the presence or absence of a face (which is assumed to be that of the authenticated user) or to track the previously authenticated user's face within the visual field of the forward-facing camera module to monitor for the uninterrupted presence of the authenticated user's face within the visual field of the camera module. If the privacy controller 130 detects that the tracked face in the image data moves out of the field of view of the camera module, the privacy controller 130 may revoke the previously granted authentication. Accordingly, when a face is again detected within the field of view of the camera module 101 (which of course, may be that of the previously authenticated user), the privacy controller 130 is then activated to authenticate the credentials of the user now in the camera module's field of view. Thus, the above process is repeated to authenticate the user now in the camera module's field of view. A new user facial vector of the currently in view user is generated and the newly generated user facial vector is compared with the facial vector of predefined facial vectors of authorised users of device 10 stored in device memory 120. Provided that the user facial vector of the newly identifies user/face within the camera module's field of view matches the stored facial vector data of authenticated users, then access to view the screen of the device is granted and the display device is unchanged. If, however, the user facial vector of the newly detected user does not match the facial vector data of an authenticated user as stored in the device memory, a threat signal is raised wherein continued access to view the display device is revoked, and the privacy controller 130 is engaged to modify the display 103 to prevent unauthorised viewing of content displayed on device display 103.

In further arrangements, the privacy controller 130 may be executed automatically whenever an authorised user of device 10 opens particular applications, specifically applications which are presumed to potentially contain sensitive information. For example, privacy controller 130 may be automatically executed by device 100 when the authorised user opens a phot gallery software application or massaging application, for example email applications such as Gmail, or Microsoft™ Outlook, short message service applications (SMS), or social networking applications such as Facebook™, Twitter™, WhatsApp™ and the like. The user may be offered a prompt when opening a software application on their portable computing device 100 whether or not the privacy controller 130 should also be executed to safeguard against possible privacy threats when using the software application, or indeed in the case where privacy controller 130 is automatically executed when opening selected software applications, the user may be given the opportunity to disable privacy controller 130.

In particular embodiments, and depending on the particular hardware modules available on the portable computing device, the privacy controller 130 may utilise three-dimensional images obtained from image sensor 101 and or optional depth sensing module. Additionally, the privacy controller may require the user to be located within a particular distance of a known object such as, for example a wall, to ensure that the is minimal opportunity for a potential non-authorised person or image recording device to be present within the field of view of image sensors 101. In particular embodiments, utilising a depth sensing image system and/or three-dimensional imagery, the user may be required to be located within a predefined distance both from the image sensor 101 and a known object behind the user, e.g., a wall.

In the event that the generated user facial vector is not matched with a stored facial vector of a predefined authorised user, privacy controller 130 sends a failure flag to processor 110 that the detected user is not authorised to access the device. In this case, processor 110 may either; display a message to the device display 130 to advise the detected user that they are not authorised to access the device; or alternatively, the privacy controller 130 may direct processor 110 to turn off display 103 such that no image or information is displayed to the user. In this case, where the display screen 103 is blacked out or switched ‘off’, the display may also be configured to display an image in a portion of the display screen which is configured to receive touch input via touch controller 105 whereby the user may be prompted to choose an alternative authentication method if such is applicable, for example, in the incidence of a false negative recognition process.

In the positive authentication case, whereby the user is correctly authenticated as an authorised user of device 100, privacy controller 130 may send a success flag to processor 110 which in turn provides input to display 130 to operate normally i.e., switched ‘on’ to display image and information to the authenticated user.

### Display Screen Privacy Protection

While the authenticated user is operating device 100, privacy controller 130 is preferably active in a background state to continuously monitor image data from forward-facing image sensor device 101 to monitor for potential breaches of the privacy of the user operating device 100.

While active, privacy controller 130 provides at least two (2) layers of privacy protection operating in real-time or near-real-time. In a first protection layer, privacy controller 130.

First of all, Facial recognition and Object detection Al modules run in real-time to process images captured through the front-facing camera of the phone in order to verify that the user is an authorized person and to ensure no device with a camera pointed at the screen (iOS and Android).

Secondly, privacy controller 130 provides protection against screenshots or screen recording of display screen 130 to stop users from deliberately capturing on-screen content as discussed below.

Privacy controller 130 may additionally include a third background real-time process to determine whether the user is situated in a location which would inherently minimise the risk of observers looking over their shoulder at display 103, for example, if the user is sitting with their back to a wall. If image sensors 101 include the ability for depth detection of elements within the image sensor field of view 102, privacy controller may also be configured to determine whether the user is sitting within a predefined distance from the wall deemed to be in a safe range where it would be difficult for an unauthorised person to stand behind the user in a position to view display screen 130, either directly behind the user or within an angle which would permit the person to view display 103.

The privacy controller 130 is configured for real-time monitoring of image data 104 from image sensor 101 when the device 100 is in use for, at least, specific applications where privacy of information displayed to display screen 102 is likely to be important to the authenticated user 150. Example applications where the privacy controller may be configured to operate by default may include image or video viewing applications (e.g., Photo Gallery and the like), messaging applications (e.g., email, social media and the like) or document viewer applications (e.g., PDF viewer). The privacy controller may be configured by the user to execute for user-specific applications when in use on their device 100.

The privacy controller is configured to detect in real-time or near-real-time all devices and facial recognition within the field of view 102 of forward-facing image sensor 101 when the authenticated user 150 is using or viewing particular applications on the portable computing device 100 including messaging or chat applications, or image or video viewing applications such as Gallery. Initially when the user opens such applications while the privacy controller is running on device 100 as a background application service, the privacy controller verifies the identity of the user as discussed above. Once user authentication is completed successfully, the privacy controller 130 continues to be active as a background application service which continually monitors the image data recorded by image sensor 101 in real-time or near-real-time such that where a change in the pixels of the image data is detected, the privacy controller will check the image data, and return a privacy flag to processor 110 if a privacy threat is detected as disclosed below.

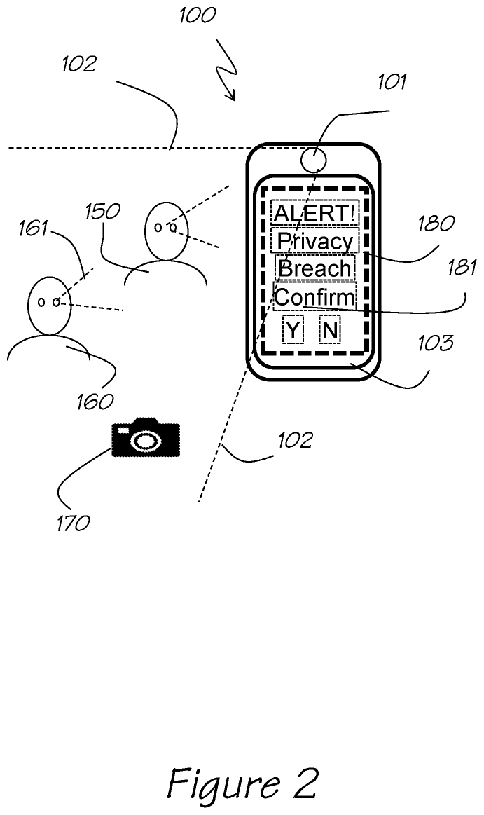

For example, as shown in FIG. 2, a device 100 is operated by authenticated user 150. Privacy controller 130 of device 100 in this example has authenticated user 150 as being permitted to use device 100 thus display 103 is set to an active state such that user 150 can operate device 100 normally. Forward-facing image sensor 101 has a field of view defined by dotted lines 102. Authenticated user 150 is positioned such that their face with within sensor field of view 102 such that privacy controller 130 can periodically generate a user facial vector of user 150's face for ongoing confirmation of user authentication if necessary.

Privacy controller 130 also continuously monitors images received from within sensor field of view 102 to detect any potential privacy concerns. For example, person 160 may enter the field of view 102 of sensors 101. In a first embodiment of the device privacy control methods described herein, privacy controller 130 may deem any occurrence of a further person with field of view 102 as a potential privacy threat. In further embodiments, privacy controller 130 may further include or be in communication with a gaze direction controller 140 of device 100. Gaze detection controller 140 may be activated by privacy controller 130 when a further person is detected within the sensor field of view 102. Gaze direction controller 140 may segment an image of person 160 and analyse the segmented image to detect if a face of user 160 is observed—in which case, person 160 is looking generally in the direction of device 100. In this case, gaze direction controller 140 may alert privacy controller 130 to a potential privacy threat. In further embodiments, gaze direction controller 140 may further analyse the face of user 160 to determine the actual gaze direction 161 of user 160 in which case to determine whether or not user 160 is looking directly at display 103 of device 100. If user 160's gaze is determined to be looking at display 130, say ‘over the shoulder’ of authenticated user 150, the gaze direction controller 140 may alert the privacy controller 130 to a potential privacy threat. In the event of a staged privacy threat alerting system, the threat degree to the privacy of user 150 being breached by an unauthorised person 160 viewing display 130, may be graded between: a low threat in the case of a person detected in field of view 130, but facing away from device 100 (no face of person 160 in view); a medium threat in the case of person 160 facing generally towards device 100 (perhaps indicating peripheral or casual/fleeting view of device display 103; or a high threat in the case of a person looking directly at display 103 of device 100 as determined by a gaze direction controller 140.

Privacy controller 130 may, in particular arrangements further include an artificial intelligence (AI) module which is capable of learning the image signatures of image and/or video recording devices to for example supplement an existing database of such recording devices such that the privacy controller is not merely limited to recognising the image signature of known image recording devices from a known collection of such devices stored in an image database accessible to the privacy controller 130. The use of a database alone is limited in that it is only able to recognise image recording devices which are known as at a particular date of when the database is compiled or last updated. Rather, with the addition of an artificial intelligence module connected to privacy controller 130, the privacy controller 130 is able to adapt to new image and/or video recording devices thus alleviating the need for regular database updates which could provide an onerous burden to the user of device 100 to continually download and install such updates. The need for regular database updates is further not ideal as the user is not provided with any protection against new image recording devices that are released to the public after the last database update, and the user is not even aware that such new devices exists, thus creating an unacceptable flaw in the efficacy of the privacy controller 130 to safeguard the user's privacy from new recording devices.

In particular arrangements for a privacy controller 130 implementation on a Apple™ brand portable computing device 100 such as, for example, an iPhone or iPad or laptop computer and the like, the user verification procedure may make use of the TrueDepth three-dimensional camera system available on these devices to perform facial identification of the user and also to determine the distance that the user is located from background elements identified in the field of view 102 of camera device 101 such as, for example a wall for advanced screen privacy functions as disclosed herein. In Android™ branded portable computing devices such as mobile phones or tablet devices, a depth-sensitive camera system may not be available so the facial recognition procedure is implemented using the two-dimensional image data form camera 101. If additional arrangements, however, many modern portable computing devices include more than one camera system, e.g., for wide-field or zoom functionality. Therefore, the systems and methods disclosed herein my utilise the image data from more than one image sensor 101 which may be used to infer depth information in the combined image data from the plurality of image sensors 101.

In further embodiments, the privacy controller 130 may also continuously monitors images received from sensor 101 within the sensor field of view 102 to detect for additional privacy concerns, for example, the appearance of a camera or image recording device 170, for example, a smartphone or tablet device or the like, within field of view 102 which may be used by an unauthorised person 160 to record an image of display 130 of device 100. In such cases of an image recording device 170 being detected within field of view 102, privacy controller 130 may immediately flag image recording device 170 as a high-level privacy threat.

In the case that a medium- or high-level privacy threat is detected by privacy controller 130 a privacy alert flag is passed to processor 101. Processor 101 may be configured to, on receipt of a privacy threat alert from privacy controller 130 to take action to preserve the privacy of the information or any images being displayed on display 103. For example, processor 110 may either; display a message to the device display 130 to advise the authenticated user of a potential privacy breach; or alternatively, the privacy controller 130 may direct processor 110 to turn off display 103. Preferably in the event that a privacy alert message 180 is displayed on display 130 of device 100 for user 150, the message may identify whether a person 160 or an image recording device 170 has been detected within field of view 102 of image sensor 101, and/or may identify the potential privacy breach grade (i.e., low- medium- or high-threat alert) to which user 150 would be prompted to check their surroundings for such potential privacy threat breach. Preferably, where the processor 104 displays a privacy threat alert message 180 on display 103, the message displayed may comprise a predefined region 181 of the displayed image receptive to touch input via touch controller 105 by authenticated user 150 to either confirm the potential threat detected, or to override the message in the event that no actual threat is evident. Preferably, displayed threat alert message 180 covers most or all of the display area of display 103 such that at least interim privacy protection is provided by message 180 at least partially or preferable mostly obscuring any image or information being displayed on display 103.

In alternative embodiments, action taken by processor 101 on receipt of a potential privacy threat alert from privacy controller 103 resulting from the continuous, real-time monitoring of the field of view 102 of image sensor 101 may comprise the action of turning display 103 to a blacked-out or ‘off’ state such that any image or data displayed on display 103 prior to receipt of the threat alert is no longer displayed and thus is not visible to both authenticated user 150 or any additional person 160 or image recording device 170 detected within field of view 102. As discussed above, in the event the screen is blacked out due to a potential privacy threat, processor 101 may also be configured to display an image in a portion of the display screen 103 which is configured to receive touch input via touch controller 105 whereby the authenticated user 150 may be prompted to confirm the privacy threat or to indicate that no such threat is evident and the display 103 is returned to the ‘on’ state such that user 150 may proceed normally to view image and/or data content on display 103. Where the user 150 confirms that a potential threat is evident, display 103 is preferably blacked-out or switched to the ‘off’ state. Display 103 may be switched off for a predetermined period of time to permit the user 150 to move to a more secure location before display 103 is switched on again. In some embodiments, processor display 103 may be configured to display a countdown timer showing a predetermined period of time before the display 103 is switched back on to allow user 150 time to move to a more secure location or otherwise secure their position for privacy of display 103. Alternatively, processor 101 may be configured to display an image or message on display 103 adapted to receive a touch input via touch controller 105 from user 150 to confirm that the privacy threat is no longer evident and that the display may be switched to the ‘on’ state such that authenticated user 150 may proceed to work normally again.

In particular arrangements of the systems and methods disclosed herein, the Al functions utilised by the privacy controller as discussed above may be provided by existing Al infrastructure, for example TensorFlow™, or Google ML Kit which are available as a software-as-a-service application to provide AI and machine-learning functionality to third-party software applications. In particular arrangements, a first AI function such as facial recognition may be provided by a first machine-learning service e.g., Google ML Kit, and a second AI function may be provided by a second machine-learning service, e.g., TensorFlow. In this manner, multiple AI services may be provided simultaneously with both sub-routines operating in real-time, without introducing a significant burden on a single machine-learning resource which may negatively impact the real-time or near-real-time operation of the privacy controller 130.

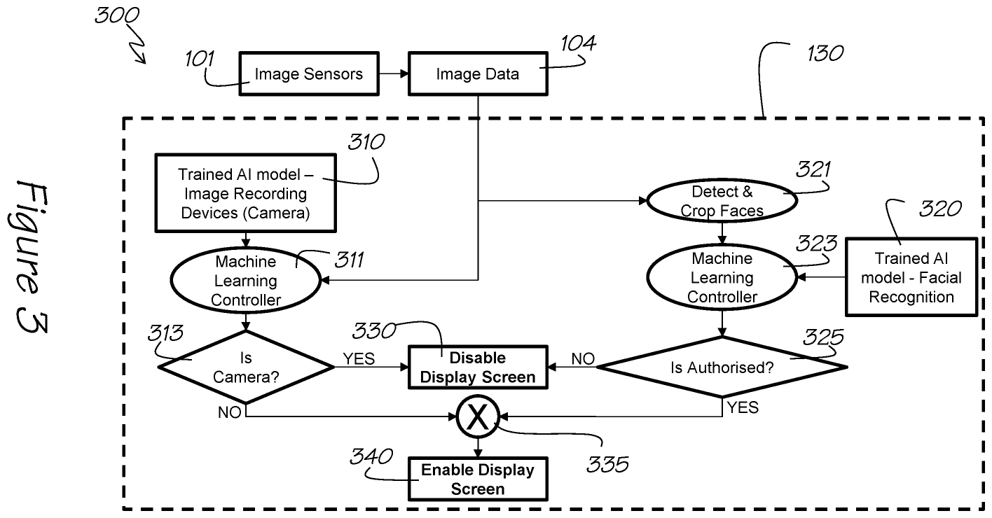

FIG. 3 provides a schematic depiction of the operation of privacy controller 130. Image data 104 representative of the field of view 102 of image sensor(s) 101 is received by privacy controller 130 and delivered to two independent sub-routines. A first subroutine comprises a trained AI model 310 configured for detection of image-recording devices in field of view image data 104.

Image data 104 is received by a first machine-learning controller 311 and compared with AI model 310 to determine whether or not 313 an image recording device (e.g., camera) is detected in field of view image data 102. If an image-recording device is detected, the display 103 of device 100 is configured to disable 330 the display screen 103 which may include hiding or masking the image and/or data being displayed on display 103. This may include either turning the display 103 to an off-state as discussed above, or optionally displaying a message on display 103 to indicate to the user 150 that a potential privacy threat in the form of an image-recording device has been detected.

Image data 104 is further forwarded to a further sub-routine to provide user authentication functionality to device 100 to ensure only authorised users 150 are permitted to view display 103. Further subroutine includes a trained Al model 320 configured with facial identification vector data corresponding to one or more authorised users 150 with permission to use portable computing device 100. In a first instance, the image data 104 is provided to image detection routine 321 where it is analysed and manipulated to provide facial image data including an isolated face (e.g., to detect and crop the image to isolate a detected face) which is detected within field of view 102 of the image sensor 101. The facial image date is provided to a second machine-learning controller 323 and compared with Al model 310 to determine whether or not 325 the detected face within image data 104 belongs to an authorised user 150 with permission to use device 100. If facial data of a user who does not have authorisation for device 100, the display 103 of device 100 is configured to disable 330 the display screen 103 which may include hiding or masking the images and data displayed thereon as discussed above. Both the image-recording subroutine and facial recognition subroutine are preferrable executed continuously in real time such that privacy controller 130 can identify potential privacy threats from image recording devices 170 or unauthorised users 160, and also to enable 340 display screen 103 to permit viewing access to display 103 in the comparison 335 between the two sub-routines where:
no image-recording devices 170 are detected at decision output 313; and
that an authorised user 150 (and only an authorised user or users i.e., no unauthorised users 160) is detected within the field of view 102 of image senor(s) 101 and able to view display 103.

As noted above, privacy controller 130 is configured to be executed as a background service on portable computing device 100 to provide continuous real-time or near-real-time monitoring of potential privacy threats to unauthorised observers viewing or recording the images and/or data being shown on display 103. In particular arrangements of privacy-protected device 100, privacy controller 130 is particularly configured to monitor the field of view 102 of image sensor(s) 101 whenever an authorised user is viewing potentially sensitive content such as, for example, image data in an image gallery application on computing device 100 or in a messaging service on computing device 100 such as email applications, social media applications (e.g., Facebook™, Instagram™ and the like), encrypted messaging services (e.g., Signal™ or Telegram™) or document viewing applications (e.g., PDF viewer). In further embodiments of the privacy controller systems and methods disclosed herein, privacy controller may further provide additional privacy detection for the taking, saving and or distributing screenshot images of images or data shown on display 103 of device 100 which includes privacy controller 130.

For example, privacy controller 130 may prevent a user who has access to device 100, from taking a screenshot of display 103 by any—device-specific—method for doing so, and also for recording a video capture of display screen 103 of device 100. Thus the function of the privacy controller 103 may be applied globally, whether that user is either an authorised user 150 or unauthorised person 160 who may have gained physical access to device 100, however briefly, is able to take screenshots or video recordings of display 103. Of course, privacy controller 130 will also preferably include an override feature whereby privacy controller 130 may be configured to provide a prompt to the user adapted to receive a touch input via touch controller 105 for an authorised user to override the screenshot blocking or display recording process. In preferred arrangements, if the user attempts to override such features, privacy controller 130 is configured to authenticate the user as an authorised user of device 100, for example via a facial recognition procedure as discussed above.

Modifications and variations such as would be apparent to the skilled addressee are considered to fall within the scope of the present invention. The present invention is not to be limited in scope by any of the specific embodiments described herein. These embodiments are intended for the purpose of exemplification only. Functionally equivalent products, formulations and methods are clearly within the scope of the invention as described herein. It will be understood by those skilled in the art that various changes in form and details may be made therein without departing from the spirit and scope of the invention as defined by the appended claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Such variations are not to be regarded as a departure from the disclosure, and all such modifications are intended to be included within the scope of the disclosure.

The method steps, processes, and operations described herein are not to be construed as necessarily requiring their performance in the particular order discussed or illustrated, unless specifically identified as an order of performance. It is also to be understood that additional or alternative steps may be employed.

Reference to positional descriptions and spatially relative terms), such as “inner”, “outer”, “beneath”, “below”, “lower”, “above”, “upper” and the like, are to be taken in context of the embodiments depicted in the figures, and are not to be taken as limiting the invention to the literal interpretation of the term but rather as would be understood by the skilled addressee.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second”, and other numerical terms when used herein do not imply a sequence or order unless clearly indicated by the context. Thus, a first element, component, region, layer or section discussed below could be termed a second element, component, region, layer or section without departing from the teachings of the example embodiments.

It will be understood that when an element is referred to as being “on”, “engaged”, “connected” or “coupled” to another element/layer, it may be directly on, engaged, connected or coupled to the other element/layer or intervening elements/layers may be present. Other words used to describe the relationship between elements/layers should be interpreted in a like fashion (e.g., “between”, “adjacent”). As used herein the term “and/or” includes any and all combinations of one or more of the associated listed items.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprise”, “comprises”, “comprising”, “including”, and “having”, or variations thereof are inclusive and therefore specify the presence of stated features, integers, steps, operations, elements, and/or components, but do not preclude the presence or addition of one or more other features, integers, steps, operations, elements, components, and/or groups thereof.

### Implementation Example—Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field-programmable gate array (FPGA) that is persistently programmed to perform the techniques, or may include at least one general-purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data centre, and/or a network of server computers and/or personal computers.

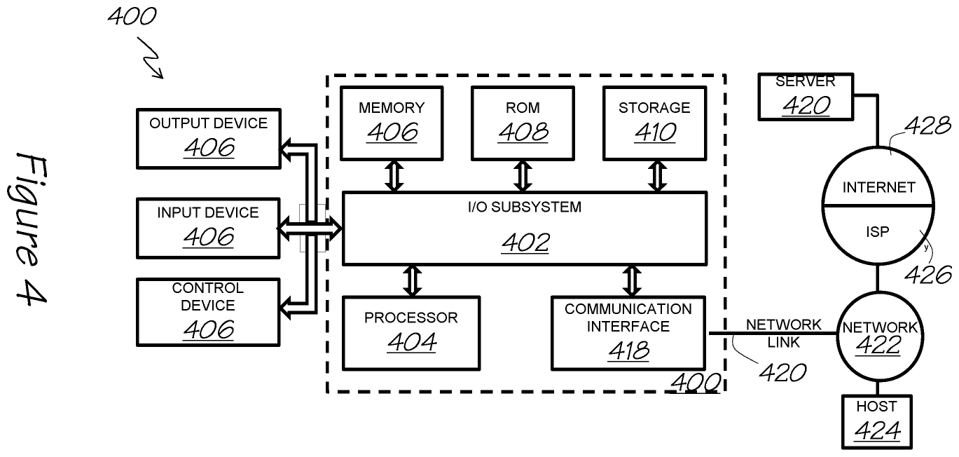

FIG. 4 is a block diagram that illustrates an example computer system with which an embodiment may be implemented. In the example of FIG. 4, a computer system 400 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 400 includes an input/output (I/O) subsystem 402 which may include a bus and/or other communication mechanism(s) for communicating information and/or instructions between the components of the computer system 400 over electronic signal paths. The I/O subsystem 402 may include an I/O controller, a memory controller and at least one I/O port. The electronic signal paths are represented schematically in the drawings, for example as lines, unidirectional arrows, or bidirectional arrows.

At least one hardware processor 404 is coupled to I/O subsystem 402 for processing information and instructions. Hardware processor 404 may include, for example, a general-purpose microprocessor or microcontroller and/or a special-purpose microprocessor such as an embedded system or a graphics processing unit (GPU) or a digital signal processor or ARM processor. Processor 404 may comprise an integrated arithmetic logic unit (ALU) or may be coupled to a separate ALU.

Computer system 400 includes one or more units of memory 406, such as a main memory, which is coupled to I/O subsystem 402 for electronically digitally storing data and instructions to be executed by processor 404. Memory 406 may include volatile memory such as various forms of random-access memory (RAM) or other dynamic storage device. Memory 406 also may be used for storing temporary variables or other intermediate information during execution of instructions to be executed by processor 404. Such instructions, when stored in non-transitory computer-readable storage media accessible to processor 404, can render computer system 400 into a special-purpose machine that is customized to perform the operations specified in the instructions.

Computer system 400 further includes non-volatile memory such as read only memory (ROM) 408 or other static storage device coupled to I/O subsystem 402 for storing information and instructions for processor 404. The ROM 408 may include various forms of programmable ROM (PROM) such as erasable PROM (EPROM) or electrically erasable PROM (EEPROM). A unit of persistent storage 410 may include various forms of non-volatile RAM (NVRAM), such as FLASH memory, or solid-state storage, magnetic disk or optical disk such as CD-ROM or DVD-ROM, and may be coupled to I/O subsystem 402 for storing information and instructions. Storage 410 is an example of a non-transitory computer-readable medium that may be used to store instructions and data which when executed by the processor 404 cause performing computer-implemented methods to execute the techniques herein.

The instructions in memory 406, ROM 408 or storage 410 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 400 may be coupled via I/O subsystem 402 to at least one output device 412. In one embodiment, output device 412 is a digital computer display. Examples of a display that may be used in various embodiments include a touch screen display or a light-emitting diode (LED) display or a liquid crystal display (LCD) or an e-paper display. Computer system 400 may include other type(s) of output devices 412, alternatively or in addition to a display device. Examples of other output devices 412 include printers, ticket printers, plotters, projectors, sound cards or video cards, speakers, buzzers or piezoelectric devices or other audible devices, lamps or LED or LCD indicators, haptic devices, actuators or servos.

At least one input device 414 is coupled to I/O subsystem 402 for communicating signals, data, command selections or gestures to processor 404. Examples of input devices 414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 416, which may perform cursor control or other automated control functions such as navigation in a graphical interface on a display screen, alternatively or in addition to input functions. Control device 416 may be a touchpad, a mouse, a trackball, or cursor direction keys for communicating direction information and command selections to processor 404 and for controlling cursor movement on display 412. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other types of control device. An input device 414 may include a combination of multiple different input devices, such as a video camera and a depth sensor.

In another embodiment, computer system 400 may comprise an internet of things (IoT) device in which one or more of the output device 412, input device 414, and control device 416 are omitted. Or, in such an embodiment, the input device 414 may comprise one or more cameras, motion detectors, thermometers, microphones, seismic detectors, other sensors or detectors, measurement devices or encoders and the output device 412 may comprise a special-purpose display such as a single-line LED or LCD display, one or more indicators, a display panel, a meter, a valve, a solenoid, an actuator or a servo.

When computer system 400 is a mobile computing device, input device 414 may comprise a global positioning system (GPS) receiver coupled to a GPS module that is capable of triangulating to a plurality of GPS satellites, determining and generating geo-location or position data such as latitude-longitude values for a geophysical location of the computer system 400. Output device 412 may include hardware, software, firmware and interfaces for generating position reporting packets, notifications, pulse or heartbeat signals, or other recurring data transmissions that specify a position of the computer system 400, alone or in combination with other application-specific data, directed toward host 424 or server 430.

Computer system 400 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 400 in response to processor 404 executing at least one sequence of at least one instruction contained in main memory 406. Such instructions may be read into main memory 406 from another storage medium, such as storage 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage 410. Volatile media includes dynamic memory, such as memory 406. Common forms of storage media include, for example, a hard disk, solid-state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fibre optics, including the wires that comprise a bus of I/O subsystem 402. Transmission media can also take the form of acoustic or light waves, such as those generated during radio-wave and infra-red data communications.

Various forms of media may be involved in carrying at least one sequence of at least one instruction to processor 404 for execution. For example, the instructions may initially be carried on a magnetic disk or solid-state drive of a remote computer. The remote computer can load the instructions into its dynamic memory and send the instructions over a communication link such as a fibre optic or coaxial cable or telephone line using a modem. A modem or router local to computer system 400 can receive the data on the communication link and convert the data to a format that can be read by computer system 400. For instance, a receiver such as a radio frequency antenna or an infrared detector can receive the data carried in a wireless or optical signal and appropriate circuitry can provide the data to I/O subsystem 402 such as place the data on a bus. I/O subsystem 402 carries the data to memory 406, from which processor 404 retrieves and executes the instructions. The instructions received by memory 406 may optionally be stored on storage 410 either before or after execution by processor 404.

Computer system 400 also includes a communication interface 418 coupled to bus 402. Communication interface 418 provides a two-way data communication coupling to a network link(s) 420 that are directly or indirectly connected to at least one communication network, such as a network 422 or a public or private cloud on the Internet. For example, communication interface 418 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fibre-optic line or a telephone line. Network 422 broadly represents a local area network (LAN), wide-area network (WAN), campus network, internetwork or any combination thereof. Communication interface 418 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 418 sends and receives electrical, electromagnetic or optical signals over signal paths that carry digital data streams representing various types of information.

Network link 420 typically provides electrical, electromagnetic, or optical data communication directly or through at least one network to other data devices, using, for example, satellite, cellular, Wi-Fi, or BLUETOOTH technology. For example, network link 420 may provide a connection through a network 422 to a host computer 424.

Furthermore, network link 420 may provide a connection through network 422 or to other computing devices via internetworking devices and/or computers that are operated by an Internet Service Provider (ISP) 426. ISP 426 provides data communication services through a worldwide packet data communication network represented as internet 428. A server computer 430 may be coupled to internet 428. Server 430 broadly represents any computer, data centre, virtual machine or virtual computing instance with or without a hypervisor, or computer executing a containerized program system such as DOCKER or KUBERNETES. Server 430 may represent an electronic digital service that is implemented using more than one computer or instance and that is accessed and used by transmitting web services requests, uniform resource locator (URL) strings with parameters in HTTP payloads, API calls, app services calls, or other service calls. Computer system 400 and server 430 may form elements of a distributed computing system that includes other computers, a processing cluster, server farm or other organization of computers that cooperate to perform tasks or execute applications or services. Server 430 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 430 may comprise a web application server that hosts a presentation layer, application layer and data storage layer such as a relational database system using a structured query language (SQL) or no SQL, an object store, a graph database, a flat-file system or other data storage.

Computer system 400 can send messages and receive data and instructions, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage 410, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 404. While each processor 404 or core of the processor executes a single task at a time, computer system 400 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DBaaS provider manages or controls the underlying cloud infrastructure, applications, and servers, including one or more database servers.

### Embodiments

Reference throughout this specification to “one embodiment”, “an embodiment”, “one arrangement” or “an arrangement” means that a particular feature, structure or characteristic described in connection with the embodiment/arrangement is included in at least one embodiment/arrangement of the present invention. Thus, appearances of the phrases “in one embodiment/arrangement” or “in an embodiment/arrangement” in various places throughout this specification are not necessarily all referring to the same embodiment/arrangement, but may. Furthermore, the particular features, structures or characteristics may be combined in any suitable manner, as would be apparent to one of ordinary skill in the art from this disclosure, in one or more embodiments/arrangements.

Similarly it should be appreciated that in the above description of example embodiments/arrangements of the invention, various features of the invention are sometimes grouped together in a single embodiment/arrangement, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment/arrangement. Thus, the claims following the Detailed Description are hereby expressly incorporated into this Detailed Description, with each claim standing on its own as a separate embodiment/arrangement of this invention.

Furthermore, while some embodiments/arrangements described herein include some but not other features included in other embodiments/arrangements, combinations of features of different embodiments/arrangements are meant to be within the scope of the invention, and form different embodiments/arrangements, as would be understood by those in the art. For example, in the following claims, any of the claimed embodiments/arrangements can be used in any combination.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word “comprise” or variations such as “comprises” or “comprising” are used in an inclusive sense, i.e., to specify the presence of the stated features but not to preclude the presence or addition of further features in various embodiments of the invention.

Any one of the terms: “including” or “which includes” or “that includes” as used herein is also an open term that also means “including at least” the elements/features that follow the term, but not excluding others. Thus, including is synonymous with and means comprising.

### Scope of Invention

Thus, while there has been described what are believed to be the preferred arrangements of the invention, those skilled in the art will recognize that other and further modifications may be made thereto without departing from the spirit of the invention, and it is intended to claim all such changes and modifications as fall within the scope of the invention. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### Industrial Applicability

It is apparent from the above, that the arrangements described are applicable to the mobile device industries, specifically for methods and systems for distributing digital media via mobile devices.

It will be appreciated that the systems and methods described/illustrated above at least substantially provide a system and method for providing increased privacy of data being displayed on a display of a portable electronic device.

The systems and methods described herein, and/or shown in the drawings, are presented by way of example only and are not limiting as to the scope of the invention. Unless otherwise specifically stated, individual aspects and components of the privacy controller described herein may be modified, or may have been substituted therefore known equivalents, or as yet unknown substitutes such as may be developed in the future or such as may be found to be acceptable substitutes in the future. The privacy controller systems and methods may also be modified for a variety of applications while remaining within the scope and spirit of the claimed invention, since the range of potential applications is great, and since it is intended that the present privacy controller systems and methods be adaptable to many such variations.

1. A system for providing privacy measures for a computing device comprising:
a memory;
a display configured to display images and/or data which may be subject to privacy concerns;
at least one image sensor configured to provide image data of a person comprising a user operating the computing device and image data of the environment surrounding the user within an image sensor field of view;
at least one processor configured to:
receive the image data to segment the image data to isolate the facial features of the user and generate a user facial vector representative of characteristics of the segmented facial image data; and
compare the user facial vector with facial vector data associated with one or more authorised device users stored in the memory; and
a privacy controller module configured to determine a privacy threat alert based on the facial vector comparison;
wherein, on receipt of a privacy threat alert from the privacy controller, the processor is configured to modify the display of the electronic device to preserve the privacy of the displayed image and/or data.

2. A system as claimed in claim 1, wherein the memory is configured for storing facial recognition data.

3. A system as claimed in claim 2, wherein the facial recognition data comprises facial vector data.

4. A system as claimed in claim 1, wherein the processor is configured to further segment the image data forming further segmented image data, to identify either, a further person, and/or an object within the field of view of the image sensor from the further segmented image data.

5. A system as claimed in claim 4, wherein the object comprises an image and/or video recording device.

6. A system as claimed in claim 4, wherein the privacy controller is configured to determine a privacy threat on the basis of the further segmented image data, such that, in use, on identification of a privacy threat, the privacy controller causes the processor to modify the display of the electronic device to preserve the privacy of the data previously being shown on the display.

7. A system as claimed in claim 1, wherein modification of the display comprises displaying an image or message at least partially obscuring the displays image or data.

8. A system as claimed in claim 1, modification of the display comprises either blacking out the display or turning the display to an ‘off’ state.

9. A computer program product for electronic device privacy, the computer program product comprising a non-transitory computer-readable storage medium having computer-readable program code portions stored therein, the computer-readable program code portions comprising:
a first portion configured to receive image data from an image sensor;
a second portion configured to segment the image data to isolate the facial features of a person comprising a user and generate a user facial vector representative of characteristics of the segmented facial image data;
a third portion configured to compare the user facial vector with facial vector data of known users authorised to access the electronic device, such facial vector data of known authorised users being stored in a memory; and
a fourth portion configured to modify a display of the electronic device to obscure or remove image or data from being displayed on the electronic device display.

10. A computer program product as claimed in claim 9, further comprising:
a fifth portion configured to further segment the image data forming further segmented image data, to identify either, a further person, or an object within the field of view of the image sensor; and
a sixth portion configured to determine a privacy threat on the basis of the further segmented image data, such that, in use, on identification of a privacy threat, the sixth portion engages the fourth portion to modify the display of the electronic device to preserve the privacy of the data previously being shown on the display.

11. A computer program product as claimed in claim 10, wherein the object comprises an image and/or video recording device.

12. A computer program product as claimed in claim 9, wherein modification of the display comprises displaying an image or message at least partially obscuring the displays image or data.

13. A computer program product as claimed in claim 9, wherein modification of the display comprises either blacking out the display or turning the display to an ‘off’ state.

14. A method of providing privacy measures for a computing device comprising the steps of: providing a display configured to display images and/or data which may be subject to privacy concerns;
providing at least one image sensor configured to provide image data of a person comprising a user operating the computing device and image data of the environment surrounding the user within an image sensor field of view;
providing at least one processor configured to:
receive the image data;
segment the image data to isolate the facial features of the user and generate a user facial vector representative of characteristics of the segmented facial image data; and
compare the user facial vector with facial vector data associated with one or more authorised device users stored in the memory; and
providing a privacy controller module configured to determine a privacy threat alert based on the facial vector comparison;
wherein, on receipt of a privacy threat alert from the privacy controller, the processor is configured to modify the display of the electronic device to preserve the privacy of the displayed image and/or data.

15. A method according to claim 14, comprising the further steps of further segmenting the image data using the processor forming further segmented image data, to identify either, a further person, and/or an object within the field of view of the image sensor.

16. A method according to claim 15, wherein the object is an image and/or or video recording device.

17. A method according to claim 14, wherein the privacy controller is configured to determine a privacy threat on the basis of the further segmented image data, such that, in use, on identification of a privacy threat, the processor is directed to modify the display of the electronic device to preserve the privacy of the data previously being shown on the display.

18. A method as claimed in claim 14, wherein modification of the display comprises displaying an image or message at least partially obscuring the displays image or data.

19. A method as claimed in claim 14, wherein modification of the display comprises either blacking out the display or turning the display to an ‘off’ state.

20. A computer program product having a computer readable medium having a computer program recorded therein for providing privacy measures for a computing device, the computing device comprising:
at least one processor;
a memory;
at least one image sensor;
a display;
said computer program product comprising:
computer program code means for displaying images and/or data which may be subject to privacy concerns;
computer program code means for receiving image data from the at least one image sensor, the image data comprising image data of a person comprising a user operating the computing device and image data of the environment surrounding the user within an image sensor field of view;
computer program code means for segmenting the image data to isolate the facial features of a user and generate a user facial vector representative of characteristics of the segmented facial image data;
computer program code means for comparing the user facial vector with facial vector data associated with one or more authorised device users stored in the memory;
computer program code means for providing a privacy controller module configured to determine a privacy threat alert based on the facial vector comparison; and computer program code means for, on receipt of a privacy threat alert from the privacy controller, the processor is configured to modify the display of the electronic device to preserve the privacy of the displayed image and/or data.

21. A computer program product as claimed in claim 20, comprising computer program code means for further segmenting the image data using the processor forming further segmented image data to identify either, a further person, or an object within the field of view of the image sensor.

22. A method according to claim 15, wherein the object is an image and/or or video recording device.
